(19) United States
(12) Patent Application Publication
(10) Pub. No.: US 2011/0310603 A1
(43) Pub. Date: Dec. 22, 2011

(54) LIGHT FIXTURES

(75) Inventor: Gregory Brian Simons, Boise, ID (US)

(73) Assignee: ABL IP Holding LLC, Conyers, GA (US)

(21) Appl. No.: 12/816,679

(22) Filed: Jun. 16, 2010

(51) Int. Cl. F21V 1/00; B23P 6/00

(52) U.S. Cl. 362/235; 29/402.08; 362/294

(57) ABSTRACT

A low-profile light fixture includes at least one lighting module comprising a frame having a top portion, one or more wall portions, a mounting portion, at least one LED mounted to the mounting portion, and a shield positioned below the mounting portion for shielding the light emitting portion of each LED from direct view. The frame optionally includes one or more dividers for dividing light from the LEDs into discrete sections of the frame. The frame and shield include a reflective material for reflecting light from the LEDs into the space to be illuminated. The light fixture can be configured so that it can be retrofitted into existing lighting fixtures.

### FIELD OF THE INVENTION

This invention relates to lighting modules for illuminating architectural spaces, particularly low profile light emitting diode-based lighting modules.

### BACKGROUND OF THE INVENTION

Traditional light fixtures typically used in office environments include a troffer with at least one fluorescent lamp and a lens having prismatic elements for distributing the light. Typical light fixtures may also use parabolic reflectors to provide a desired light distribution. The fluorescent lamp has long been the light source of choice among lighting designers in many commercial applications, particularly for indoor office lighting. A description of such a fluorescent light fixture may be found in U.S. Pat. No. 7,229,192, the contents of which are hereby incorporated by reference.

For many years the most common fluorescent lamps for use in indoor lighting have been the linear T5 (⅝ inch diameter), T8 (1 inch diameter), and the T12 (1½ inch diameter). Such bulbs are inefficient and have a relatively short lamp life. Thus, efforts have been made to identify suitable alternative illumination sources for indoor office lighting applications. Light emitting diodes (“LEDs”) have been identified as one alternative to traditional fluorescent bulbs.

An LED typically includes a diode mounted onto a die or chip, where the diode is surrounded by an encapsulant. The die is connected to a power source, which, in turn, transmits power to the diode. An LED used for lighting or illumination converts electrical energy to light in a manner that results in very little radiant energy outside the visible spectrum. LEDs are extremely efficient, and their efficiency is rapidly improving. For example, the lumen output currently obtained by 20 LEDs may soon be obtained by only 10 LEDs.

In view of this, LEDs would appear to be an ideal choice for use in suspended mechanical ceilings (i.e., drop ceilings), which typically include recessed lighting fixtures that are configured to be flush with the ceiling. These lighting fixtures, commonly referred to as troffer fixtures, are suspended from and secured in the ceiling by a “grid” of t-frames, which also suspend the ceiling tiles in the ceiling. Light fixtures for use in suspended mechanical ceilings should preferably have a low profile, i.e., require a minimum amount of space above the “grid” so that the fixture does not interfere with obstructions above the grid such as plumbing and HVAC or electrical ducting.

LED light fixtures, and in particular low-profile LED light fixtures, are therefore desirable.

### SUMMARY OF EMBODIMENTS OF THE INVENTION

Embodiments of the light fixture can include one or more lighting modules comprising a frame having a top portion, one or more wall portions, a light source mounting portion, at least one LED mounted to the mounting portion, and optionally a shield positioned below the mounting portion for shielding the light emitting portion of each LED from direct view.

The frame optionally includes one or more dividers for dividing light from the LEDs into discrete sections of the frame.

The frame and shield optionally include a reflective material for reflecting light from the LEDs into the space to be illuminated.

The lighting module can be configured so that it can be retrofitted into existing lighting fixtures.

### BRIEF DESCRIPTION OF THE DRAWINGS

FIG. 1 is a bottom view of a lighting module according to one embodiment of the invention.

FIG. 1A is a perspective view of a lighting module according to the embodiment of FIG. 1.

FIG. 1B is a bottom view of a lighting module according to another embodiment of the invention.

FIG. 1C is a perspective view of a lighting module according to the embodiment of FIG. 1B.

FIG. 2 is a bottom view of a lighting module according to another embodiment of the invention.

FIG. 2A is a perspective view of a lighting module according to the embodiment of FIG. 2.

FIG. 3 is a bottom view of a lighting module according to another embodiment of the invention.

FIG. 3A is a perspective view of a lighting module according to the embodiment of FIG. 3.

FIG. 4 is a bottom view of a shield for a lighting module according to one embodiment of the invention.

FIG. 4A is a perspective view of the shield according to the embodiment of FIG. 4.

FIG. 5 is a bottom view of a shield for a lighting module according to another embodiment of the invention.

FIG. 5A is a perspective view of the shield according to the embodiment of FIG. 5.

FIG. 6 is a perspective view of a heat sink according to one embodiment of the invention.

FIG. 7 is a perspective view of a heat sink according to another embodiment of the invention.

### DETAILED DESCRIPTION OF EMBODIMENTS OF THE INVENTION

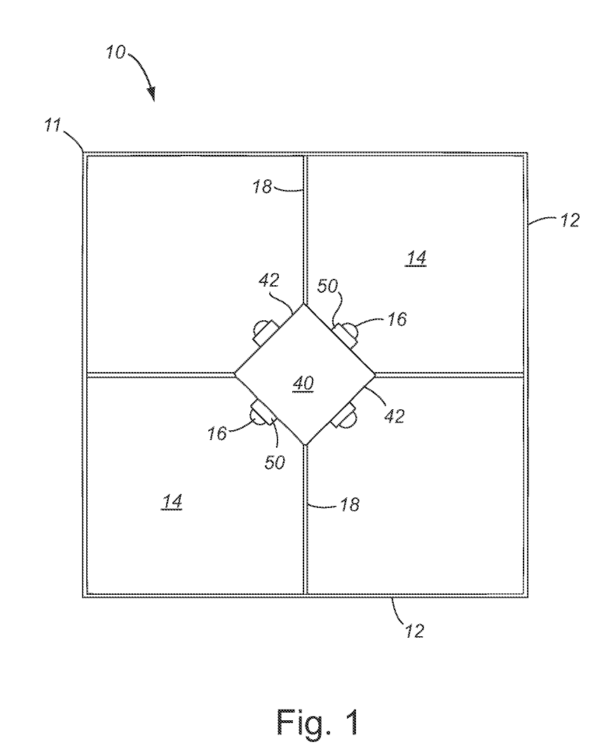

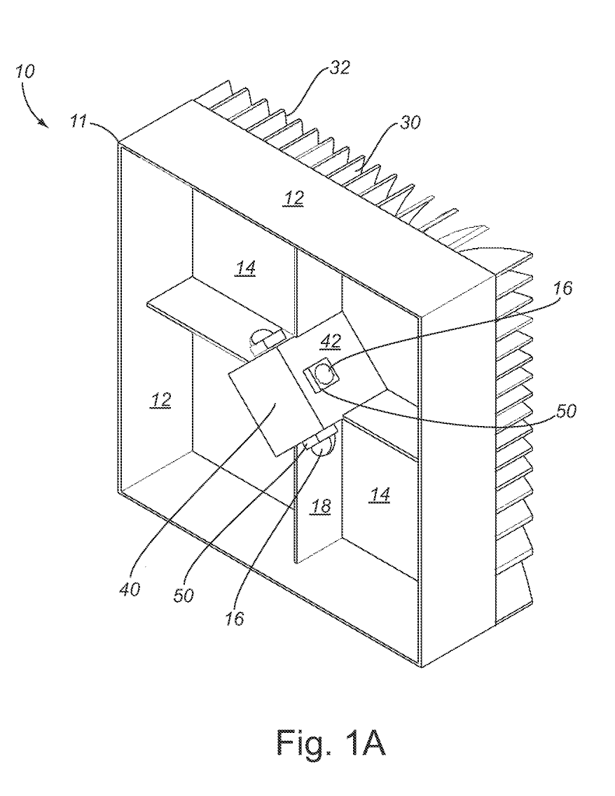

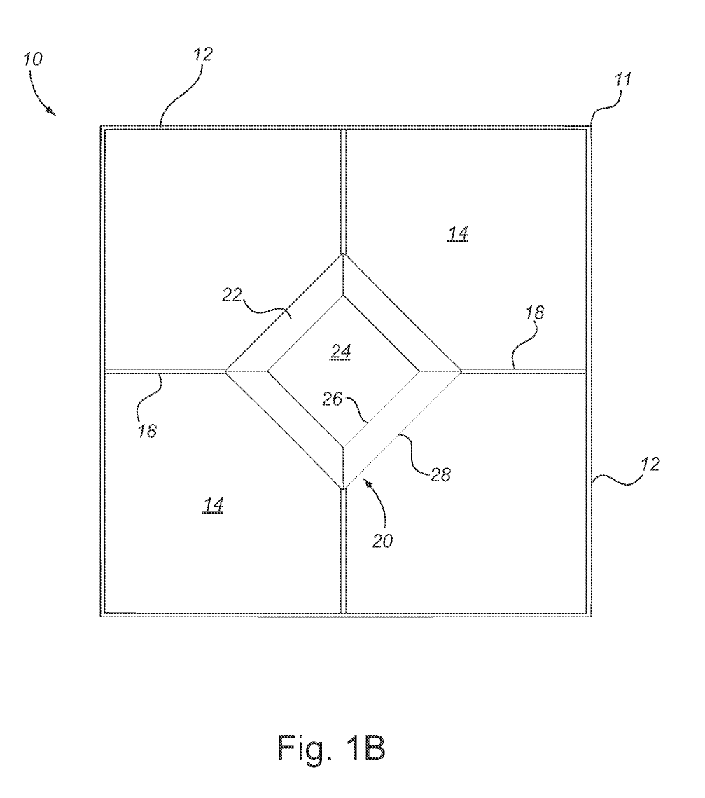

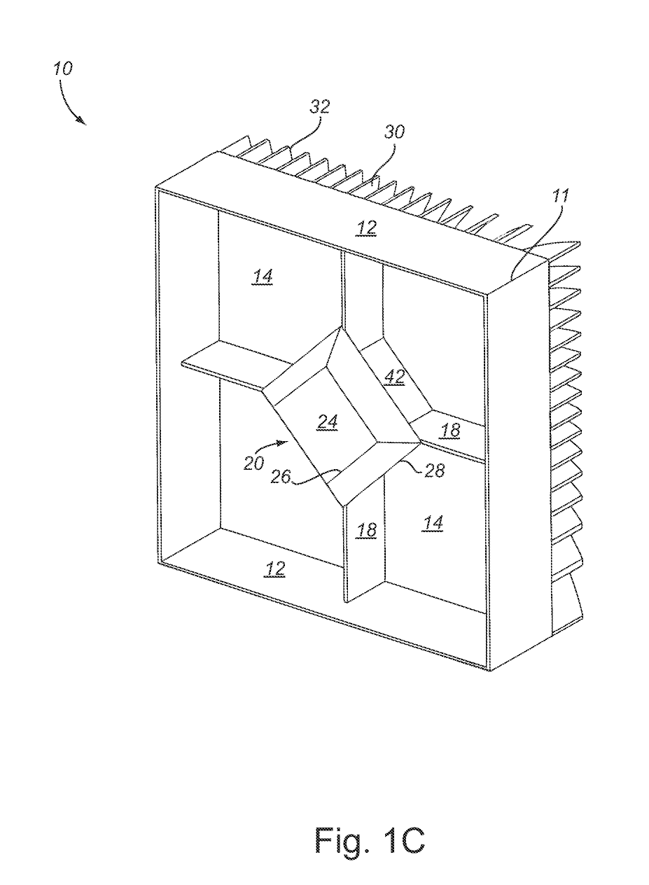

In one embodiment of the present invention, as shown in FIGS. 1, 1A, 1B and 1C, a lighting module 10 includes a frame 11, a plurality of light sources including, but not limited to, light emitting diodes (“LEDs”) 16, and optionally a shield 20. The lighting module can, but does not have to, have a low profile (i.e., its height is minimized) so that it can be positioned in a ceiling without requiring substantial space above the plane of the ceiling (unlike most currently existing recessed fixtures). A single lighting module can form a light fixture or, alternatively, multiple lighting modules can be provided within a single light fixture.

The LEDs 16 may be single-die or multi-die light emitting diodes, DC or AC, or can be organic light emitting diodes (“O-LEDs”). The lighting module 10 need not use only white LEDs 16. Rather color or multicolor LEDs 16 may be provided. Nor must all of the LEDs 16 within the lighting module 10 be the same color.

The frame 11 includes at least one wall portion 12, a top portion 14, a light source mounting portion 40 and optionally one or more dividers 18. When configured for use as a recessed lighting module, the top portion 14 and wall portion(s) 12 of frame 11 are positioned within the ceiling above the ceiling plane so that light emitted from the lighting module is directed downwardly out of the lighting module and into the space to be illuminated below the ceiling. While the lighting module 10 is described for use in a recessed lighting fixture, one of skill in the art will readily recognize that the features disclosed herein have applicability in a variety of other types of fixtures and are not limited to use in recessed lighting fixtures.

The frame 11 optionally includes a plurality of dividers 18. The dividers 18 can be configured to divide light from the LEDs 16 into various portions of the frame 11. The dividers can be configured so as to more evenly distribute light from the LEDs 16 throughout the frame 11 or to enhance the aesthetics of the light generated in the lighting module 10. The dividers 18 can also be shaped to provide light effects as desired.

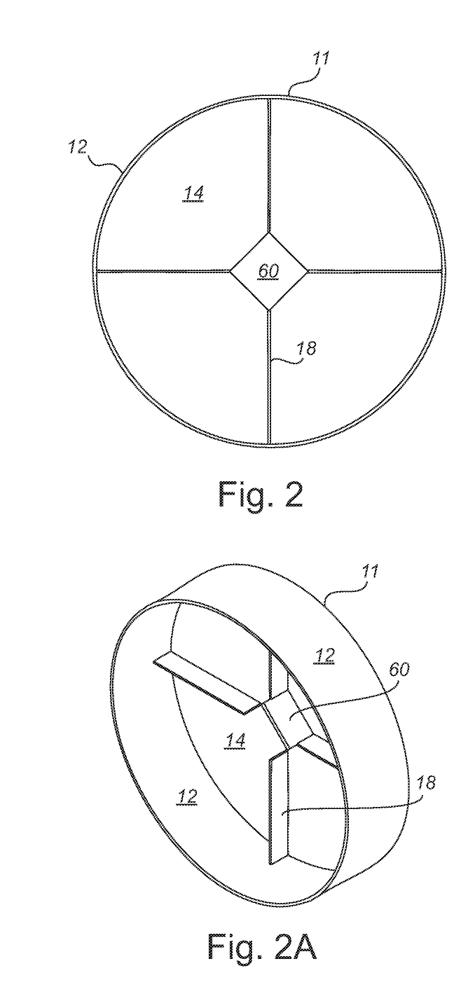

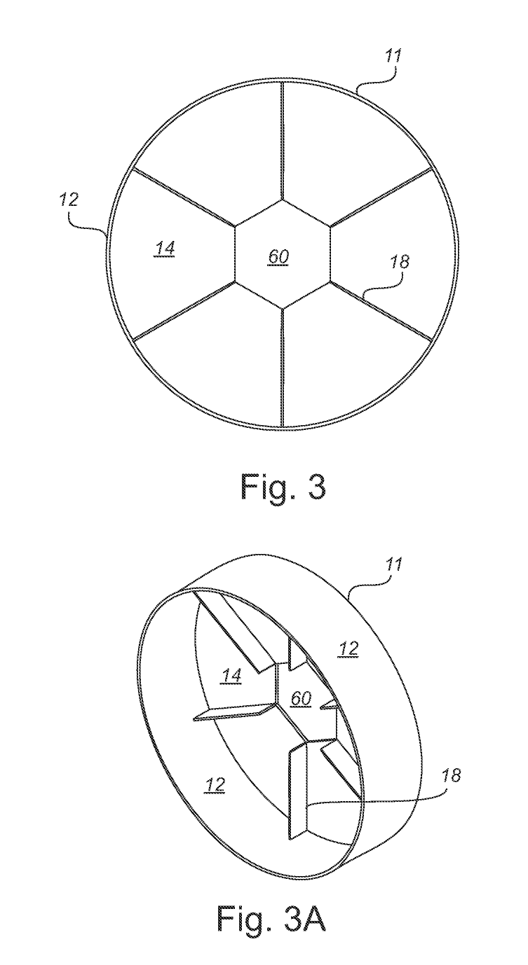

The frame 11 also includes a top portion 14 which, in one embodiment, includes a recess 60 (as shown in FIGS. 2, 2A, 3 and 3A) that receives the light source mounting portion 40. In other embodiments the light source mounting portion 40 is not a separate component from the frame 11 but rather is integrally-formed with the frame 11. Mounting portion 40 includes a plurality of surfaces 42 onto which any number of LEDs 16 can be mounted in any orientation.

The frame 11, including wall portion(s) 12, top portion 14 and optional dividers 18 may be formed of any thermally conductive material, including but not limited to metallic (e.g., aluminum), plastic or a highly reflective material as discussed below. In some embodiments, the frame 11 can be extruded into any desirable lighting module shape or design. While illustrated in FIGS. 1, 1A, 1B and 1C as a square frame 11 with dividers 18 extending substantially towards the center of wall portions 12, the frame 11 may have any desirable shape as exemplified in FIGS. 2 and 2A (a circular frame 11 with four dividers 18) and 3 and 3A (a circular frame with six dividers 18). These shapes allow multiple lighting module 10 to be placed adjacent to each other to form desired patterns and/or light output levels. In addition, various downlight sizes can be created (e.g., 4″, 6″ or 8″) by using more powerful LEDs 16 or a greater number of LEDs 16.

One or more surfaces of the frame 11, including the wall portion(s) 12, top portion 14 and/or optional dividers 18 preferably have extremely high surface reflectivities, preferably, but not necessarily, between 96%-99.5%, inclusive and more preferably 98.5-99%. To achieve the desired reflectivity, in one embodiment the surfaces of the frame 11 are coated with a diffuse, reflective material, including, but not limited to, reflective paints. Alternatively, the surfaces of the frame 11 could include a layer of a reflective flexible sheet of material such as one or more of the materials sold under the tradenames GL-22, GL-80, GL-30 or Optilon™, all available from DuPont. Alternative materials include Miro® reflective aluminum materials, available from Alanod, and micro cellular polyethylene terephthalate (“MCPET”), available from Furukawa. The reflective material may be substantially glossy or substantially flat. In one example, the reflective material is preferably matte white to diffusely reflect incident light. Other embodiments may utilize textured or colored paints or impart a baffled shape to the surfaces of the frame 11 to obtain a desired reflection. Alternatively, the frame 11 itself can be formed from a reflective material so that the surfaces of the frame 11 need not be separately treated to attain the desired reflectivity.

As explained above, one or more LEDs 16 are preferably installed onto a printed circuit board (“PCB”) 50, and one or more PCBs 50 are installed onto the surface(s) 42 of mounting portion 40. As shown, surface(s) 42 preferably faces wall portion 12 such that the light emitted from the LED(s) 16 is directed towards the wall portion 12 of the frame 11. In some embodiments, at least some of the LED(s) 16 are mounted and arranged so that their emitted light is directed towards the top portion 14 of the frame 11.

The PCB 50 can be, among other things, metal core board, FR4 board, CHM1 board, etc. While only one LED 16 is shown mounted on each PCB 50, any number of LEDs 16 may be mounted on a PCB 50 at any number of locations. Moreover, multiple PCBs 50 may be provided on each surface 42.

Although shown in FIGS. 1, 1A, 1B and 1C as attached to PCBs 50, which are attached to the mounting portion 40 on surfaces 42, it will be understood that the LEDs 16 may alternatively be individually affixed to the frame 11 or can be affixed to the frame 11 as a linear array, or bank, of LEDs 16. The LEDs could be directly affixed to the frame 11 with the use of chip-on-board technology.

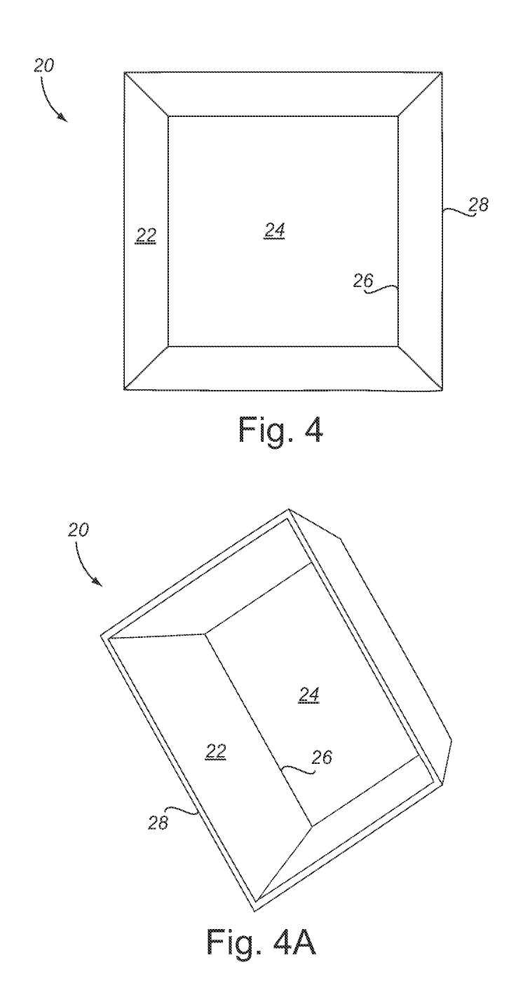

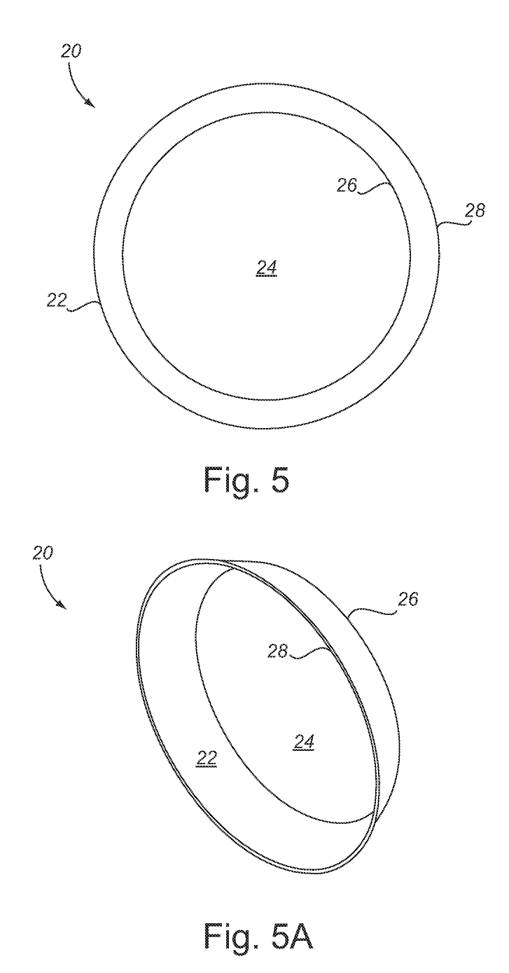

As illustrated in FIGS. 1B and 1C, a shield 20 may be affixed (either permanently or removably) to the frame 11. Additional illustrations of a shield 20 are provided in FIGS. 4, 4A, 5 and 5A. The shield 20 is positioned and designed to block the light emitted from the LEDs 16 from escaping directly out of the lighting module 10 and thus causing glare issues. The shield 20 may be formed of any thermally conductive material, including, but not limited to, aluminum. The shield 20 could also be formed from, or include as a layer, a highly reflective material to preserve as much light output as possible, directing it back into the frame 11 where it could be diffused and emitted. This highly reflective material could be diffuse or specular and, for example, white or silver. Exemplary materials for a highly reflective material for the shield 20 (or for the shield 20 itself or as a layer applied to the shield 20) include Optilon™, composite reflective films available from DuPont, Miro® reflective aluminum materials, available from Alanod, and micro cellular polyethylene terephthalate (“MCPET”), available from Furukawa. The shield 20 could be integrally formed with the frame 11 or could be attachable to the frame 11 with a bracket, clamp or other traditional mounting apparatus (not illustrated).

Although illustrated in FIGS. 4, 4A, 5 and 5A as having at least one side 22 and a bottom portion 24, it will be recognized that the shield 20 could be substantially two-dimensional (i.e., it need not have side portion 22). When the shield is installed, light from the LEDs 16 is at least partly directed into the shield 20 (or onto the shield 20 as applicable) and reflects off the surface(s) of the shield 20 (such as side(s) 22 and bottom portion 24) and into the frame 11. The shield 20 thus prevents direct light from the LEDs 16 from passing into the space to be illuminated. It will also be recognized that the shield 20 can have any suitable shape, such as the substantially square shape shown in FIGS. 4 and 4A or the substantially circular shape shown in FIGS. 5 and 5A. Moreover, the side(s) 22 of the shield 20 can be curved or angled to help direct reflected light back into the frame 11 and eventually out of the lighting module 10. In one embodiment, the length 26 of the side 22 proximate the bottom portion 24 is shorter than the length 28 of the side 22 farthest from the bottom portion 24, and the side 22 is thus angled outwards from the bottom portion 24.

During operation of the lighting module 10, light from the LEDs 16 is directed into the frame 11, reflects diffusely off the reflective surfaces of the frame 11 and then propagates out of the lighting module 10. Thus, although the lighting module 10 uses point sources of light, the light exiting the lighting module 10 is of uniform luminance.

The LEDs 16 are preferably positioned to emit light in a direction that ranges from parallel to perpendicular with the top portion 14 in a direction toward the top portion 14. The light emitted from the LEDs 16 is thus directed towards the wall portion 12 or upwards towards the top portion 14. Alternatively, the LEDs 16 could be positioned so that the direct light points downwards towards the shield 20 (i.e., in a direction that ranges from parallel to perpendicular with the shield 20) so that it can be reflected back into the frame 11 and eventually reflected out of the lighting module 10.

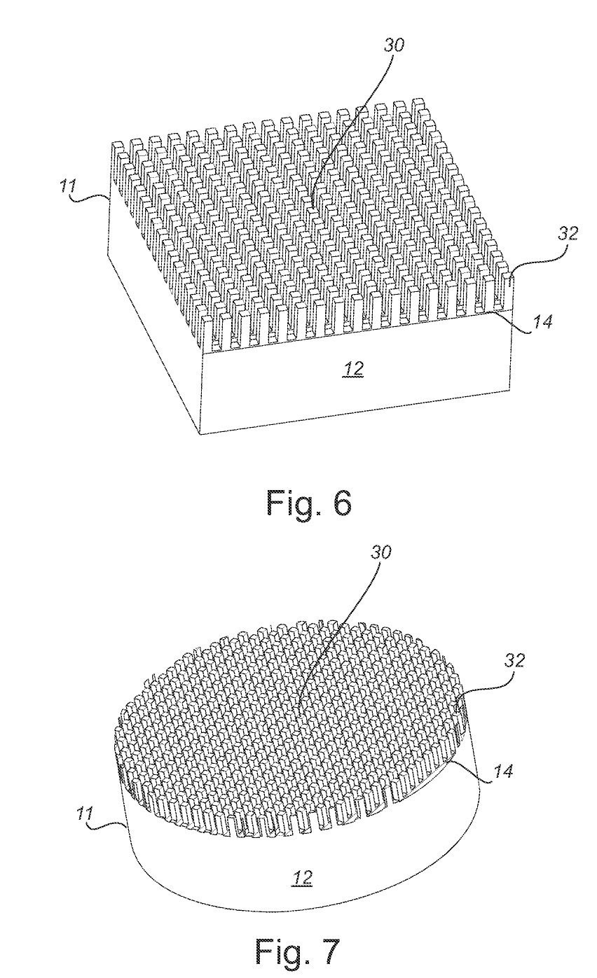

Although LEDs generate less heat than incandescent bulbs of comparable light output, heat dissipation is still a consideration, particularly when several LEDs are located close to one another. Accordingly, as illustrated in FIGS. 1A, 1C, 6 and 7 a heat sink 30 can optionally be used in the lighting module 10 to dissipate heat generated by LEDs 16. The heat sink 30 is coupled to the top portion 14 of frame 11 and includes a plurality of heat dissipation surfaces, or fins 32, for enhancing the removal of heat generated from the LEDs 16 that passes through the frame 11. The heat sink 30 can be integrally formed with the frame 11 or can be coupled to the frame using a mechanical fastener such as a screw.

Embodiments of the LED-based lighting module described herein can be used in a wide variety of lighting applications to replace traditional fluorescent bulbs, such as accent lighting applications, or—if the amount of light propagating out of the lighting module 10 is sufficient—area lighting applications. Because the frame 11 may be extruded to any desirable shape, the lighting module 10 disclosed herein may easily be tailored to accommodate the dimensions of traditional fixtures and thus may be easily retrofitted into such fixtures.

Embodiments of the lighting modules contemplated herein may be retrofitted into existing fluorescent fixtures, including, but not limited to, recessed lighting fixtures. Such retrofitting would require electrical and mechanical modifications to the fixture. For example, the ballast of an existing fixture could be replaced with an LED driver to power the LEDs. Moreover, the fixture (such as the fixture housing) would need to be adapted to mechanically support the LED lighting module(s) 10. A person skilled in the art could make the required electrical and mechanical modifications to retrofit an existing fluorescent fixture with embodiments of the LED lighting module described herein.

The foregoing is provided for purposes of illustrating, explaining, and describing embodiments of the present invention. Further modifications and adaptations to these embodiments will be apparent to those skilled in the art and may be made without departing from the scope or spirit of the invention.

We claim:

1. A lighting module comprising:
a frame comprising a top portion, one or more wall portions, and a light source mounting portion;
a plurality of LEDs mounted to the light source mounting portion; and
a shield positioned below the light source mounting portion for shielding from direct view light emitted by the LEDs,
wherein at least a portion of the frame or the shield comprises a reflective material.

2. The lighting module of claim 1, wherein the frame further comprises at least one divider for dividing light emitted from the LEDs into discrete portions of the frame.

3. The lighting module of claim 1, wherein light emitted from at least some of the plurality of LEDs is emitted in a direction that ranges from parallel to perpendicular with the top portion in a direction toward the top portion.

4. The lighting module of claim 1, wherein light emitted from at least some of the plurality of LEDs is emitted in a direction that ranges from parallel to perpendicular with the shield in a direction toward the shield.

5. The lighting module of claim 1, wherein the frame comprises metal, plastic, a composite reflective material, a reflective aluminum material, micro cellular polyethylene terephthalate or combinations thereof.

6. The lighting module of claim 1, wherein the frame comprises extruded aluminum.

7. The lighting module of claim 1, wherein the reflective material is painted onto, coated onto, or attached to the at least a portion of the frame or the shield.

8. The lighting module of claim 7, wherein the reflective material is a composite reflective material, a reflective aluminum material, micro cellular polyethylene terephthalate or combinations thereof.

9. The lighting module of claim 1, wherein the frame or the shield are formed from the reflective material.

10. The lighting module of claim 1, further comprising a heat sink adjacent the frame for dissipating heat generated by the plurality of LEDs.

11. The lighting module of claim 10, wherein the heat sink is adjacent the top portion of the frame.

12. A light fixture comprising at least one lighting module of claim 1.

13. A light fixture comprising a plurality of lighting modules of claim 1.

14. A lighting module comprising:
a frame comprising a top portion, one or more wall portions, a mounting portion onto which at least one LED is mounted and one or more dividers for dividing light emitted from the at least one LED into discrete portions of the frame;
a shield positioned below the mounting portion for shielding from direct view light emitted by the at least one LED; and
a heat sink adjacent the frame for dissipating heat generated by the at least one LED,
wherein at least one of the frame and the shield comprises a reflective material painted onto, coated onto, or attached to the at least one of the frame and the shield.

15. A method for retrofitting an existing light fixture with a light emitting diode lighting module, comprising:
removing an existing light source from the existing light fixture;
providing at least one light emitting diode lighting module comprising:
a frame comprising a top portion, one or more wall portions, and a mounting portion;
at least one LED mounted to the mounting portion;
a shield positioned below the mounting portion for shielding from direct view light emitted by the at least one LED,
wherein at least one of the frame and the shield comprises a reflective material; and
installing the light emitting diode lighting module into the existing light fixture.

16. The method of claim 15, wherein the frame further comprises one or more dividers for dividing light emitted by the at least one LED into discrete sections of the frame.
